(19) United States
(12) Patent Application Publication
(10) Pub. No.: US 2018/0319288 A1
(43) Pub. Date: Nov. 8, 2018

(54) Ethanol-Fueled Fuel Cell Powered Aircraft

(71) Applicant: Bell Helicopter Textron Inc., Fort Worth, TX (US)

(72) Inventors: Phalgun Madhusudan, Bangalore (IN); Aditya Battin, Bangalore (IN); Bharatesh Kalasur, Bangalore (IN)

(73) Assignee: Bell Helicopter Textron Inc., Fort Worth, TX (US)

(21) Appl. No.: 15/589,885

(22) Filed: May 8, 2017

(51) Int. Cl. B60L 11/18; B64D 27/24; B64D 35/02; B64C 27/12; B64C 27/82

(52) U.S. Cl. CPC B60L 11/1883; B64D 27/24; B64D 35/02; B64C 27/12; B64D 2041/005; B60L 2200/10; B60L 2220/16; B60L 2220/14; B64C 27/82

(57) ABSTRACT

An aircraft has an ethanol fuel storage, an ethanol-fueled fuel cell selectively connected to the ethanol fuel storage, and a power management unit configured to receive electrical power from the ethanol-fueled fuel cell.

### BACKGROUND

Aircraft, such as, but not limited to, helicopters, typically utilize petroleum based fuels to fuel combustion engines. However, typical combustion engines are inefficient and account for a significant amount of energy loss from tank-to-wing (TTW). Accordingly, alternative fuels and power sources have been considered for rotorcraft and other vehicles. In some cases, fuel cells have been utilized in vehicles to replace or supplement conventional combustion engines. However, many fuel cells utilize hydrogen as a fuel. Because hydrogen is relatively difficult to generate, gather, and/or store, hydrogen is undesirable as an energy source for a fuel cell associated with a rotorcraft.

### BRIEF DESCRIPTION OF THE DRAWINGS

FIG. 1 is an orthogonal left side view of a helicopter according to an embodiment of this disclosure.

FIG. 2 is a schematic depiction of a power system of the helicopter of FIG. 1.

FIG. 3 is a flowchart of a method of powering a rotor system of a rotorcraft according to an embodiment of this disclosure.

### DETAILED DESCRIPTION

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

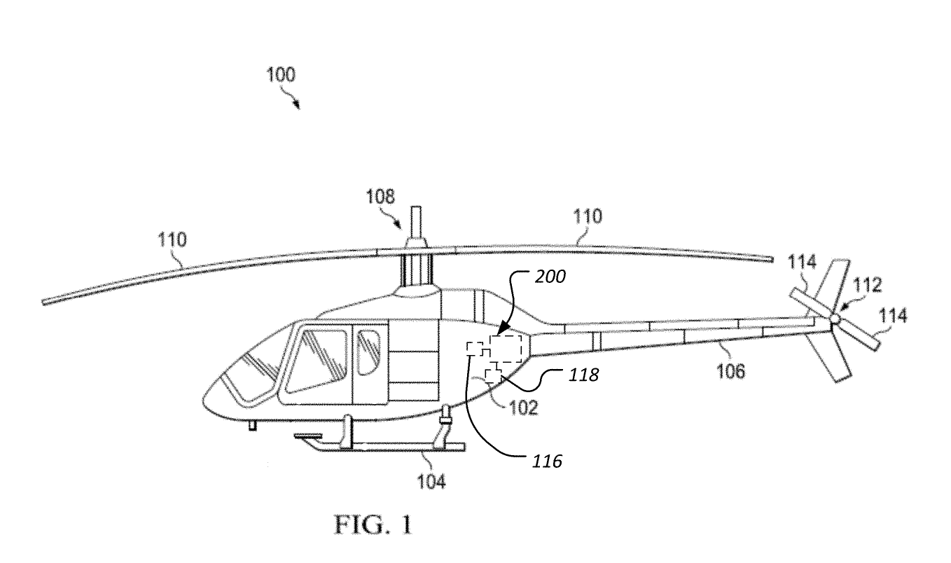

Referring to FIG. 1 in the drawings, a helicopter 100 is illustrated. Helicopter 100 can include a fuselage 102, a landing gear 104, a tail member 106, a main rotor system 108 comprising main rotor blades 110, and a tail rotor system 112 comprising tail rotor blades 114. The main rotor blades 110 and the tail rotor blades 114 can be rotated and selectively controlled in order to selectively control direction, thrust, and lift of helicopter 100. In this embodiment, the helicopter 100 further comprises an electric motor 116 configured to receive electrical power from a power system 200. In this embodiment, the electric motor 116 is configured to drive the main rotor system 108 to selectively move the main rotor blades 110. In alternative embodiments, additional electrical motors can be powered by the power system 200 to selectively drive the tail rotor system 112 to selectively move the tail rotor blades 114. In some cases, the main rotor system 108 and/or the tail rotor system 112 can be referred to as propulsion systems of the helicopter 100.

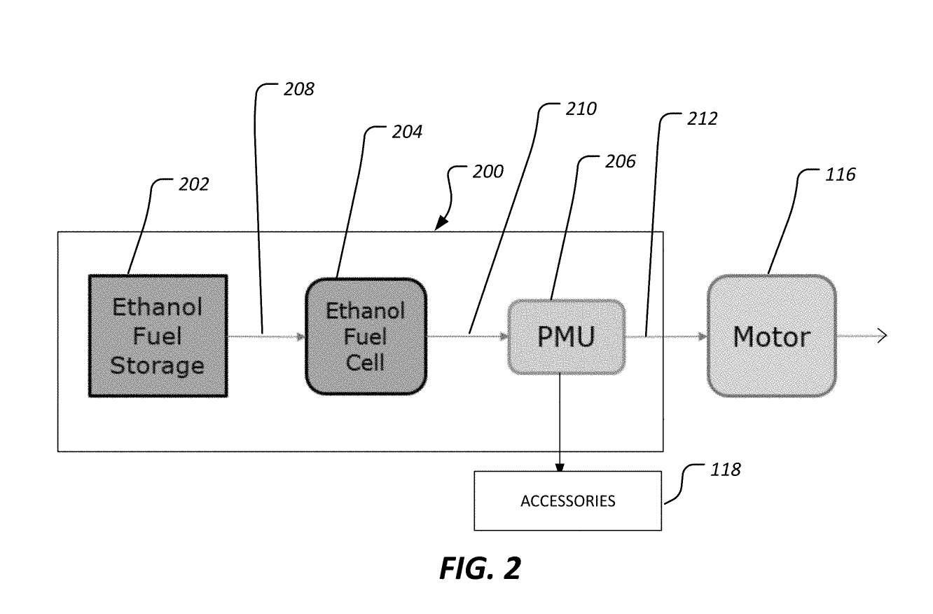

Referring now to FIG. 2 in the drawings, a schematic depiction of the power system 200 is shown. The power system 200 most generally comprises an ethanol fuel storage 202, an ethanol-fueled fuel cell 204, and a power management unit 206. The ethanol fuel storage 202 comprises any suitable tank, bag, and/or other reservoir capable of receiving and storing ethanol. The ethanol fuel storage 202 is connected to the ethanol-fueled fuel cell 204 by a fuel conduit 208 configured to allow fluid communication between the ethanol fuel storage 202 and the ethanol-fueled fuel cell 204. In this embodiment, the ethanol-fueled fuel cell 204 comprises a proton exchange membrane and is configured to combust ethanol and to output electrical energy. The electrical energy generated by the ethanol-fueled fuel cell 204 is delivered to the power management unit 206 via an electrical power supply conduit 210. The power management unit 206 is generally configured to receive and/or condition electrical power received from the ethanol-fueled fuel cell 204 and deliver electrical energy via a motor power conduit 212 to one or more electrical actuators, such as but not limited to electrical motors 116. Most generally, the power management unit 206 comprises power electronics necessary to condition power, switch between power outputs, dissipate power, and/or otherwise selectively direct electrical power to other components. While the power system 200 is described above as providing electrical power to motors 116, in alternative embodiments, the power system 200 can be configured to provide electrical power to any other at least partially electrically powered propulsion system for an aircraft and/or other vehicle or device.

In some embodiments, the use of the ethanol-fueled fuel cell 204 to power one or more propulsion systems (such as the main rotor system 108 and/or the tail rotor system 112) reduces the power requirements of any internal combustion engine and/or gas turbines as propulsion power sources. In some cases, the helicopter 100 can be fully powered by the power system 200 so that no internal combustion engine and/or gas turbines are needed for propulsion. In some cases, the high specific energy of the proton exchange membrane fuel cells such as the ethanol-fueled fuel cell 204 can extend the range of the helicopter as compared to a substantially similar helicopter that utilizes an internal combustion engine and/or gas turbines.

In this embodiment, the ethanol-fueled fuel cell 204 is configured to combust ethanol and to provide substantially continuous operational electrical power output. The power management unit 206 is configured to draw power from the ethanol-fueled fuel cell 204 and feed the electrical power to the electrical motor 116 and/or any other electrical motor configured to assist with propulsion of the helicopter 100. As compared to hydrogen and other fuel cell fuels, ethanol is easily available and the required transportation infrastructure for ethanol delivery and storage is already in place. In some embodiments, the electrical motor 116 comprises a brushless direct current motor. In some cases, when the power management unit 206 is supplied more electrical power than needed from the ethanol-fueled fuel cell 204, the power management unit 206 is configured to supply at least some of the extraneous electrical power to accessories 118 of the helicopter 100. The accessories 118 can comprise internal and external lighting, communications equipment, avionics systems, and/or any other device or system that can be electrically powered.

While 40%-50% efficiency is achievable utilizing the above-described ethanol-fueled fuel cell 204, it is contemplated that even greater efficiency can be obtained by utilizing an ethanol-fueled fuel cell comprising nanoparticle catalysts. For example, a non-platinum carbon-based catalyst can be employed as an anode catalyst in fuel cells fed with ethanol. Alternatively and/or additionally, a non-precious metal carbon-based cathode catalyst can be used in direct alcohol fuel cells where ethanol is fed directly into the fuel cell. One supplier of such nanoparticle catalyst technology is Acta S.p.A. of Via di Lavoria, 56/G-56040, Crespina (PI), Italy. In particular, Acta provides a catalyst, HYPERMEC, that is based on non-noble metals, mixtures of Fe, Co, and Ni at the anode and Ni, Fe, and Co at the cathode. The catalyst generally comprises tiny metal particles that are fixed onto a substrate so that they produce a very active catalyst that is free of platinum and can be mass produced at low cost. The above-described catalysts can be active below freezing, compatible with ethylene glycol as fuel, and are stable up to 800 degrees Celsius. In some cases, the catalysts are not affected by fuel cross-overs and can work with novel substrate stack designs. The above-described catalysts can contribute to generation of comparable power to conventional Pt—Re catalysts and with ethanol as the fuel, surface power densities as high as 140 mW/cm2 at 0.5V can be obtained at 25 degrees Celsius. In alternative embodiments, enzymatic biocatalysts may be utilized in addition to and/or instead of the above-described catalysts.

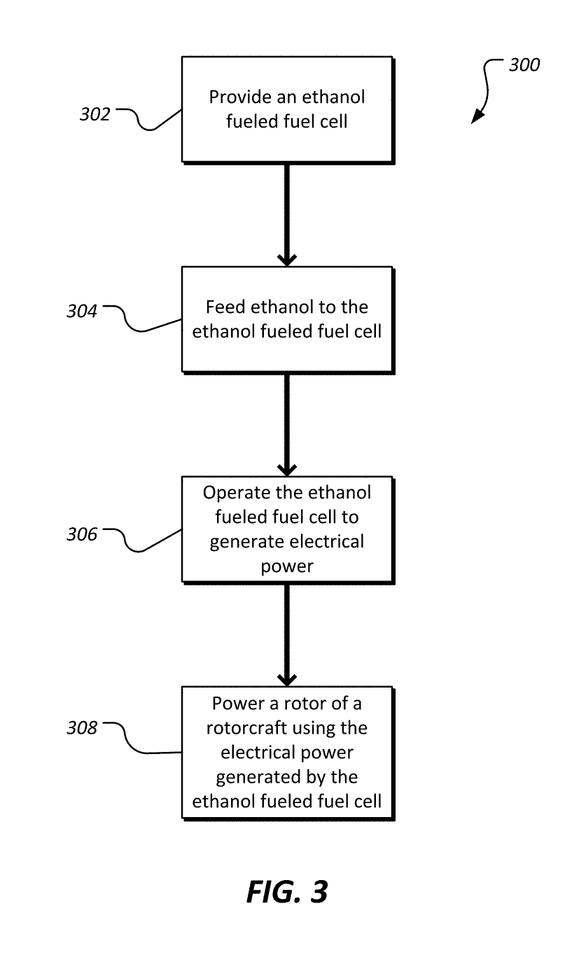

Referring now to FIG. 3, a method 300 of powering a rotor system of a rotorcraft is shown. The method 300 can begin at block 302 by providing an ethanol-fueled fuel cell. Next, the method 300 can continue at block 304 by feeding ethanol to the ethanol-fueled fuel cell. The method 300 can continue at block 306 by operating the ethanol-fueled fuel cell to generate electrical power. The method 300 can continue at block 306 by powering a rotor system of a rotorcraft using the electrical power generated by the ethanol-fueled fuel cell.

In some simulations of a helicopter comprising a power system 200, an increase in range and/or endurance has been predicted. Specifically, for a helicopter having a gross takeoff weight of 1669 kilograms, requiring a maximum power of 377 kW, a maximum continuous power of 342 kW, a cruise power of 264 kW, an endurance power of 245 kW, having an ethanol-fueled fuel cell weighing 188.5 kg (for a total power system weight of 529.769 kg), and having a payload limitation of 539.231 kg, it was predicted that the helicopter theoretical maximum endurance could be about 3.424 hours and the helicopter theoretical maximum range could be about 773.24 kilometers. While the calculations disclosed above are examples specific to helicopters, similar methodologies are contemplated for use with any other suitable aircraft, vehicle, or device that may utilize a power systems substantially similar to power system 200.

While the power system 200 described above is primarily discussed with regard to use with rotorcraft, it is contemplated that the power system 200 can be utilized in other vehicles (such as automobiles), specialized vehicles, and/or other power system energy storage applications.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. An aircraft, comprising:
an ethanol fuel storage;
an ethanol-fueled fuel cell selectively connected to the ethanol fuel storage; and
a power management unit configured to receive electrical power from the ethanol-fueled fuel cell.

2. The aircraft of claim 1, further comprising:
an electrical actuator comprising a motor configured to receive power from the power management unit.

3. The aircraft of claim 2, further comprising:
an at least partially electrically powered propulsion system.

4. The aircraft of claim 3, wherein the at least partially electrically powered propulsion system comprises rotor blades, wherein an electrical motor is configured to selectively rotate the rotor blades.

5. The aircraft of claim 4, wherein the rotor system is a main rotor system.

6. The aircraft of claim 4, wherein the rotor system is a tail rotor system.

7. The aircraft of claim 1, wherein the ethanol-fueled fuel cell is configure to substantially continuously provide operational electrical power output sufficient to power a rotor system.

8. The aircraft of claim 7, wherein the power management unit is configured to selectively direct electrical power that is unused by the rotor system to an electrically powered accessory.

9. The aircraft of claim 8, wherein the electrically powered accessory comprises a battery.

10. The aircraft of claim 1, wherein the ethanol-fueled fuel cell comprises nanoparticle catalysts.

11. The aircraft of claim 1, wherein the ethanol-fueled fuel cell comprises an enzymatic biocatalyst.

12. A method of powering a propulsion system of an aircraft, comprising:
providing an ethanol-fueled fuel cell;
feeding ethanol to the ethanol-fueled fuel cell;
operating the ethanol-fueled fuel cell to generate electrical power; and
powering a propulsion system of an aircraft using the electrical power.

13. The method of claim 12, wherein the powering the propulsion system comprises operating a brushless direct current motor or a permanent magnet synchronous motor.

14. The method of claim 12, wherein at least a portion of the electrical power is directed to an accessory.

15. The method of claim 14, wherein the accessory comprises a battery.

16. The method of claim 12, wherein the propulsion system comprises a main rotor system.

17. The method of claim 12, wherein the propulsion system comprises a tail rotor system.

18. The method of claim 12, wherein the ethanol-fueled fuel cell is about 40% to about 50% efficient.

19. The method of claim 12, wherein the ethanol-fueled fuel cell comprises a nanoparticle catalyst.

20. The method of claim 12, wherein the ethanol-fueled fuel cell comprises an enzymatic biocatalyst.
